(19) United States
(12) Patent Application Publication
(10) Pub. No.: US 2022/0017298 A1
(43) Pub. Date: Jan. 20, 2022

(54) SYSTEMS AND METHODS FOR REMOVING SEDIMENT FROM STORAGE TANKS WITHOUT TANK ENTRY

(71) Applicant: Production Waste Solutions, Andrews, TX (US)

(72) Inventor: James Varner, Andrews, TX (US)

(21) Appl. No.: 17/375,095

(22) Filed: Jul. 14, 2021

Related U.S. Application Data
(60) Provisional application No. 63/052,022, filed on Jul. 15, 2020.

(51) Int. Cl. B65D 88/72; B01D 37/00; B01D 36/00

(52) U.S. Cl. CPC B65D 88/72; B01D 36/00; B01D 37/00

(57) ABSTRACT

Removing sediment from storage tanks without physically entering the tanks. More specifically, embodiments are directed towards inserting fluid into the storage tank via a liquid return line and injecting air into the storage tank via an air injection line to suspend sediment, draining and filtering the sediment, and returning the filtered fluid back into the tank via the liquid return line.

### BACKGROUND INFORMATION

### Field of the Disclosure

Examples of the present disclosure are related to systems and methods for removing sediment from storage tanks without a user physically entering the tanks. More specifically, embodiments are directed towards inserting fluid into the storage tank via a liquid return line and injecting air into the storage tank via an air injection line to suspend sediment, draining and filtering the sediment, and returning the filtered fluid back into the storage tank via the liquid return line, wherein the liquid return line is positioned above the air supply line.

### Background

One of the environmental problems in petroleum refining is the accumulation of sediments in the bottoms of storage tanks. These sediments, which may accumulate, are required to be removed from the storage tanks in order to maintain storage tank volume as well as to prevent or decrease contamination of the products moving through the storage tanks. These sediments are: difficult to handle efficiently, adherent, solid or semi-solid, and cannot be moved by conventional fluid handling equipment, such as pumps.

Current practices for storage tank cleaning requires a maintenance crew physically entering the storage tanks to remove the sediments mechanically as a solid material, are time-consuming, labor-intensive and a higher cost for refineries. As an alternative, some companies have resorted to water-washing or solvent removal techniques. Water washing has typically been accomplished by jetting water with a dispersant into the sediments to break it up and soften it. After which, a suction hose can be inserted into the storage tank. This requires safety company crews, roustabout crews, vacuum trucks, etc.

Accordingly, needs exist for more effective and efficient systems and methods for removing sediment from a storage tank.

### SUMMARY

Embodiments disclosed herein describe systems and methods for loosening and agitating sediment that has settled at the bottom of a storage tank, suspending the sediment within the fluid in the storage tank, removing the sediment and fluid from the storage tank, processing the fluid to remove the sediment, and injecting the processed fluid back into the storage tank. This enables a closed-loop system with no or minimal external fluid being required for a cleaning job. Further, the filtered fluid may be utilized by other systems on locations after processing a storage tank. Utilizing a closed-loop system will reduce costs associated with cleanouts and will eliminate the need for super vacuums, roustabouts, vacuum trucks, and external fluids.

The storage tank removal system may include a storage tank, air injection line, liquid return line, drain line, and filter.

The storage tank may be any type of container that is configured to hold large amounts of fluids. For example, the storage tank may be an oilfield storage tank that is configured to serve as a staging area to collect crude oil in several stages of production. The storage tank may include a top orifice, which may be an opening on or proximate to an upper surface of the storage tank. The storage tank may also include a drain fitting, which may be an opening on or proximate to a lower surface or lower rim of the storage tank. In embodiments, the drain fitting may be positioned with a sediment or solids layer within the storage tank, which may be below a fluid layer.

The air injection line may be a pliable hosing the is configured to be inserted into through the top orifice, extend downward to the lower surface of the tank through the liquid level and into a solids layer of sediment positioned within the storage tank, and be positioned along a lower surface of the tank. In embodiments, the air injection line may be configured to cross a central axis of the storage tank in a direction that is substantially perpendicular to the central axis of the storage tank and substantially in parallel to the lower surface of the storage tank.

The air injection line may be configured to inject air into the sediments positioned below the liquid level in the storage tank. The injected air may move the sediments to de-solidify the sediments and suspend them within the liquid layer. In embodiments, the air injection line may include a weighted nozzle that is configured to allow the air injection line to be positioned through the storage tank, and also control the air being injected out of the nozzle. The weighted nozzle may also be configured to allow the air injection line to automatically move within the storage tank while remaining in the sediment layer to injecting air through the air injection line, wherein the injected air causes the weighted nozzle to move. This movement of the weighted nozzle may allow the nozzle to freely move from a first side of the storage tank to a second side of the storage tank, across multiple lateral and vertical axis, while also changing an angularity of the emitted air. The movement of the weighted nozzle may allow the injected air to interface with more of the sediment and to interface with the sediment at different angles, which may more effectively de-solidify the sediments.

The liquid return line may be configured to be inserted into the storage tank through the top orifice, and emit liquid into the storage tank within the solid layer. The liquid return line may be positioned above the air injection line within the solid layer. The liquid return line may have a first end coupled to the filter, and the second end may be configured to emit the liquid within the storage tank. In embodiments, the liquid return line may be configured to emit fluid continuously, before air is injected into the storage tank, or after air is injected into the storage tank.

The drain line may be configured to remove sediments and liquids from within the storage tank. The drain line may have a first end coupled to the drain fitting and a second end coupled to the filter. Before, after, or while the air injection line is emitting air and/or the liquid return line is emitting liquid, the drain line may be configured to allow sediments and liquids to move from the storage tank to the filter. In embodiments, the drain line may be coupled with at least one pump, which may aide in the moving of the sediments and liquids from the storage tank to the filter.

The filter may be a centrifuge that is configured to separate and remove the sediments from the drained fluid. The filter may be configured to supply the filtered fluid to the liquid return line. The filter may be configured to remove the sediments, and move the sediments into a separate storage container for removal. To filter the drained liquid, the filter may allow the drained liquid within the filter to flow downward into a sub-chamber, wherein the sub-chamber there are no or minimal sediments. From the sub-chamber, the filtered liquid can be pumped back into the storage tank via the liquid return line.

To this end, embodiments may be configured to provide a cleaning system that removes sediments from storage tanks at lower costs, faster and more efficiently, while eliminating high pressure washing systems that may cause erosion to the storage tank.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a topology 1 for a system to clean a storage tank, according to an embodiment.

FIG. 2 depicts a method to clean a storage tank, according to an embodiment.

FIG. 3 depicts a nozzle 00 for an air injection line, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

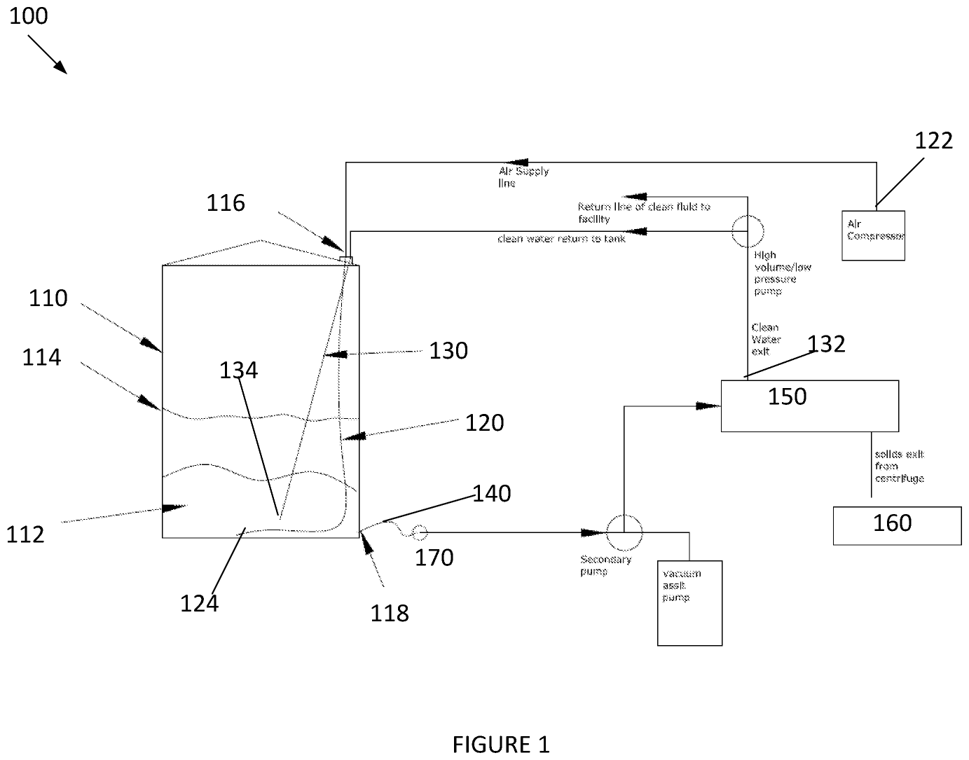

Turning now to FIG. 1, FIG. 1 depicts a topology 100 for a system to clean a storage tank 100. Topology 100 may include storage tank 110, air injection line 120, liquid return line 130, drain line 140, and filter 150.

Storage tank 110 may be any type of container that is configured to hold large amounts of fluids, solids, air, or any substance. For example, storage tank 110 may be an oilfield storage tank that serves as a staging area to collect crude oil in several stages of production. Accordingly, storage tank 110 may include solids or sediments 112 positioned below fluid 114 within storage tank 110 based on the specific gravity of sediments 112 being greater than that of the fluid 114 within the storage tank 110. Over time, the sediments 112 may move to the lower surface of surface tank 110 and form a sediment layer within storage tank 110 below the fluid layer within storage tank 110, wherein these sediments may begin to solidify. Storage tank 110 may include a top orifice 116 positioned on or close to an upper surface of storage tank 110, and a drain fitting 118 positioned on or close to a lower surface of storage tank 110. In embodiments, the drain fitting 118 may be positioned directly above or adjacent to a lower rim of storage tank 110, which may be positioned below a fluid layer within the storage tank.

Air injection line 120 may be pliable hosing, tubing, etc. that has a first end 122 that is configured to be coupled to an air compressor, and a second end 124 that is configured to be positioned within the solid layer within storage tank 110. Air injection line 120 may be inserted into storage tank 110 through top opening 116, and sink to a bottom of storage tank 110 to be positioned within the solid layer. Air injection line 120 may initially cross a central axis of the storage tank 110 within the solid layer in a direction that is substantially perpendicular to the central axis of storage tank 110 and substantially in parallel to the lower surface of storage tank 110. As such, a length of the air injection line 120 may be at least as long as the sum of the height of the storage tank 110 and half the circumference or width of storage tank 110. In embodiments, first end 122 of air injection line 120 may receive compressed air from the air compressor, and second end 124 of air injection line 120 may be configured to discharge the compressed air within the solid layer of sediments 112 within storage tank 110. Responsive to discharging the compressed air within the solid layer of sediments 112, sediments 112 within the solid layer may fragment, de-solidify, etc., move and become suspended in the liquid layer. This may allow the relative viscosity of the solid layer to decrease, such that sediments 112 may be removed from the solid layer of storage tank 110 via drain line 140. Furthermore, responsive to second end 124 injecting compressed air within storage tank 110, second end 124 may move based on forces created by the injected air. This may automatically change an injection angle and position of second end 124 to have a non-uniform path. In embodiments, the air injection line 120 may be formed of a substantially weighted hose, such as a fifty pound hose.

Liquid return line 130 may be a device that is configured to emit liquid into the solid layer to decrease the viscosity of the solid layer. Liquid return line 130 may have a first end 132 coupled to filter 150, and a second end 134 positioned within the solid layer within storage tank 110. Second end 134 may be configured to be positioned further away from a lower end of storage tank 110 than the second end 124 of air injection line 120. This may enable liquid to be injected into or above sediments 112 that are not solidified. This may assist in the removal of the sediments 112 within storage tank 110. In embodiments, the liquid return line 130 may be comprised of substantially rigid tubing, such as aluminum tubing, which may have a shorter length than air injection line 120. In embodiments, liquid return line 130 may be configured to continuously emit fluid, emit fluid after air injection line 130 has emitted air, and/or after air injection line 130 has emitted air.

Drain line 140 may be configured to remove fluids and sediments from storage tank 110. Drain line 140 may have a first end that is coupled to drain fitting 118 of storage tank 110, and a second end that is coupled to an inlet of filter 150. Drain line 140 may be configured to continually pull sediments 112 and fluid 114 from storage tank 110 via at least one vacuum pump 170, which provides a suction force from storage tank 110 towards filter 150.

Filter 150 may be a centrifuge that is configured to separate and remove sediments 112 from fluid 114. Filter 150 may be configured to supply the filtered fluid to first end 132 of liquid return line, and the removed sediments into a separate storage container 160 for removal. In embodiments, filter 150 may have a plurality of sensors that are configured to determine the ratio of fluid to sediments entering filter 150. Responsive to filter 150 receiving fluids and sediments from drain line 140, the fluid may be separated from the sediments and positioned in a sub-compartment, positioned below the fluid.

The filtering of fluids and sediments may continue until the ratio of fluid to sediments is above a desirable threshold. In use because sediments are continually leaving the system, over time the amount of sediments within the system may substantially drop. In other embodiments, responsive to a percentage, volume, or other criteria of solids being removed from the filter 150 being below a center threshold, filter 150 may return the fluid with the undesirable percentage, volume, ratio, etc. to other systems on location, and not return the fluid to storage tank 110. This may enable a ratio of fluids and sediment within storage tank 110 to remain substantially constant and/or at desirable levels.

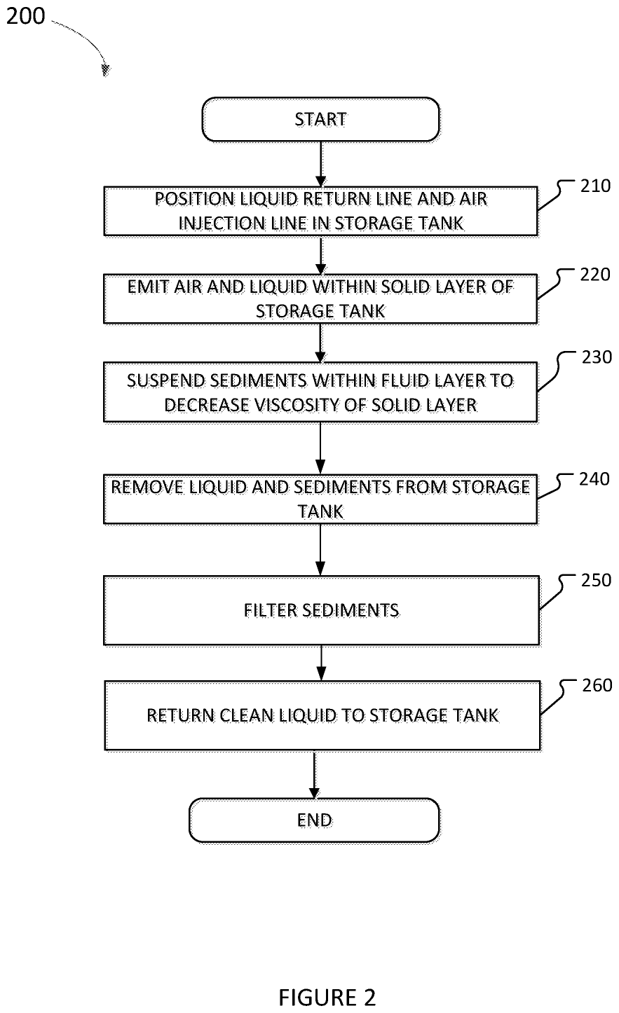

FIG. 2 illustrates a method 200 for using a storage tank cleaning system. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

At operation 210, a liquid return line and air injection line may be positioned within a storage tank. The ends of the lines may be positioned within a layer formed of sediments that have settled at the bottom of the storage tank.

At operation 220, liquid may be emitted from the liquid return line while air is injected via the air injection line.

At operation 230, due to the injected air, sediments within the solid layer may move to a liquid layer positioned above the solid layer within the storage tank, which may decrease the relative viscosity of the sediments within the solid layer due to more liquid interfacing with sediments. Further, liquid may be emitted from the liquid return line into the solid layer, which may further decrease the relative viscosity of the sediments within the solid layer.

At operation 240, liquids and sediments from the storage tank may be vacuumed through a drain fitting, and transported to a filter.

At operation 250, the sediments may be separated from the liquids via the filter, and positioned within a secondary storage container.

At operation 260, the filtered liquid may be returned to the storage tank via the liquid return line.

This process may continue until a ratio of liquid to sediments that is removed from the storage tank at operation 240 is above a desirable threshold. Due to sediments being continually removed from the closed loop system and retaining the same level of fluid, the volume of sediment within the system will continually decline while the volume of fluid within the system may remain substantially constant.

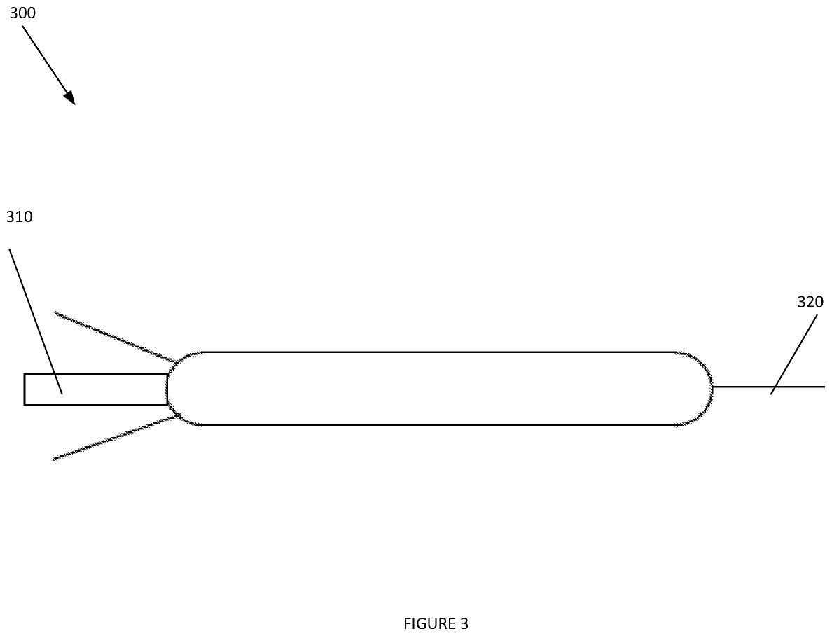

FIG. 3 depicts a nozzle 300 for an air injection line, according to an embodiment. Nozzle 300 may be a weighted nozzle that is configured to be coupled to an end of the air injection line. Nozzle 300 may be weighted to assist in dropping nozzle 300 within the storage tank to the lower surface of the storage tank, through the fluid and solid layers. Nozzle 300 may have a plurality of fins on a proximal end 310 of nozzle 300 that may assist in moving nozzle through storage tank 300. The distal end 320 of nozzle 300 may be configured

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A system associated within sediment removal comprising:
a storage tank with a top opening and drain fitting, the top opening being positioned vertically above the drain fitting;
an air injection line configured to discharge compressed air within the storage tank, the air injection line having an air inlet and an air outlet, wherein the air outlet is configured to freely move within the storage tank based on the discharged compressed air;
a liquid return line configured to emit liquid into the storage tank, the liquid return line having a liquid inlet and a liquid outlet, the liquid outlet being positioned above the air outlet within the storage tank.

2. The system of claim 1, wherein the air injection line is configured to cross a central axis of the storage tank within the storage tank.

3. The system of claim 2, wherein a length of the air injection line is longer than a length of the liquid return line.

4. The system of claim 2, wherein the liquid return line does not cross the central axis of the storage tank within the storage tank.

5. The system of claim 2, wherein the air injection line is a fifty pound hose and the liquid return line is formed of rigid tubing.

6. The system of claim 1, wherein the storage tank includes a fluid layer and a sediment layer, the sediment layer positioned below the fluid layer, wherein the air injection line is configured to discharged the compressed air within the sediment layer, and the liquid return line is configured to emit the liquid into the within the sediment layer.

7. The system of claim 1, further comprising:
an air compressor configured to supply the compressed air to the air inlet;
a drain line with a vacuum pump configured to remove fluid and sediments from the storage tank;
a filter configured to receive and filter the removed fluid and sediments from the storage tank, the filter also being configured to supply filtered fluids to the liquid inlet of the liquid return line.

8. The system of claim 7, wherein the filter is configured to filter the removed fluid and sediments until a ratio of fluids to sediments is above a desired threshold.

9. The system of claim 8, wherein the system is a closed system with no external inputs.

10. The system of claim 7, wherein the drain line is positioned at a bottom of the storage tank within the sediment layer.

11. A method associated within sediment removal comprising:
positioning an air injection line within a storage tank, the storage tank having a top opening and drain fitting, the top opening being positioned vertically above the drain fitting;
positioning a liquid return line within the storage tank;
discharge compressed air within the storage tank via the air injection line, the air injection line having an air inlet and an air outlet, wherein the air outlet is configured to freely move within the storage tank based on the discharged compressed air;
emitting liquid into the storage tank via the liquid return line, the liquid return line having a liquid inlet and a liquid outlet, the liquid outlet being positioned above the air outlet within the storage tank.

12. The method of claim 11, wherein the air injection line is configured to cross a central axis of the storage tank within the storage tank.

13. The method of claim 12, wherein a length of the air injection line is longer than a length of the liquid return line.

14. The method of claim 12, wherein the liquid return line does not cross the central axis of the storage tank within the storage tank.

15. The method of claim 12, wherein the air injection line is a fifty pound hose and the liquid return line is formed of rigid tubing.

16. The method of claim 11, wherein the storage tank includes a fluid layer and a sediment layer, the sediment layer positioned below the fluid layer, wherein the air injection line is configured to discharged the compressed air within the sediment layer, and the liquid return line is configured to emit the liquid into the within the sediment layer.

17. The method of claim 11, further comprising:
supplying the compressed air to the air inlet via an air compressor positioned outside of the storage tank;
removing fluid and sediments from the storage tank via a drain line with a vacuum pump;
receiving and filtering, via a filter outside of the storage tank, the removed fluid and sediments from the storage tank,
supplying, via the filter, the filtered fluids to the liquid inlet of the liquid return line.

18. The method of claim 17, further comprising:
filtering the removed fluid and sediments until a ratio of fluids to sediments is above a desired threshold.

19. The method of claim 18, wherein the system is a closed system with no external inputs.

20. The method of claim 17, wherein the drain line is positioned at a bottom of the storage tank within the sediment layer.
